(19) United States
(12) Patent Application Publication
(10) Pub. No.: US 2014/0022970 A1
(43) Pub. Date: Jan. 23, 2014

(54) METHODS, SYSTEMS, AND MEDIA FOR PARTIAL DOWNLOADING IN WIRELESS DISTRIBUTED NETWORKS

(71) Applicants: Chen Gong, La Jolla, CA (US); Xiaodong Wang, Ramsey, NJ (US)

(72) Inventors: Chen Gong, La Jolla, CA (US); Xiaodong Wang, Ramsey, NJ (US)

(21) Appl. No.: 13/948,123

(22) Filed: Jul. 22, 2013

Related U.S. Application Data
(60) Provisional application No. 61/674,264, filed on Jul. 20, 2012.

(51) Int. Cl. H04W 52/02

(52) U.S. Cl. CPC H04W 52/0203
USPC 370/311

(57) ABSTRACT

Methods, systems, and media for partial downloading in wireless distributed networks are provided. In some embodiments, methods for selecting numbers of symbols to be transmitted on a plurality of channels are provided, the methods comprising: for each of the plurality of channels, calculating using a hardware processor an increase in power that will be used by that channel if it transmits a symbol; selecting one of the plurality of channels with the smallest increase in power using the hardware processor; and allocating the symbol to the one of the plurality of channels using the hardware processor.

### CROSS REFERENCE TO RELATED APPLICATION

This application claims the benefit of U.S. Provisional Patent Application No. 61/674,264, filed Jul. 20, 2012, which is hereby incorporated by reference herein in its entirety.

### STATEMENT REGARDING GOVERNMENT FUNDED RESEARCH

This invention was made with government support under Grant No. CCF-0726480 awarded by the National Science Foundation (NSF) and Grant No. N00014-08-1-0318 awarded by the Office of Naval Research (ONR). The government has certain rights in the invention.

### TECHNICAL FIELD

Methods, systems, and media for partial downloading in wireless distributed networks are provided.

### BACKGROUND

Distributed storage systems are generally used to store data in a distributed manner to provide reliable access to the stored data. For example, a data file of size M can be divided into k fragments, each of size M/k. Each of the k fragments can be encoded and stored in a storage node of a distributed storage system. In such an example, the original data file can be recovered from a set of k encoded fragments. However, conventional approaches to reconstructing data stored in a distributed storage network have limited performance, especially for wireless distributed storage networks. For example, such approaches generally include downloading all of the symbols from a subset of the storage nodes. Such a full-downloading approach becomes inefficient in a wireless network, where wireless channels may not offer sufficient bandwidths for full downloading (e.g., due to channel fading). Moreover, full-downloading suffers from power constraints of the wireless network.

### SUMMARY

In accordance with some embodiments of the disclosed subject matter, methods, systems, and media for partial downloading in wireless distributed networks are provided.

In some embodiments, methods for selecting numbers of symbols to be transmitted on a plurality of channels are provided, the methods comprising: for each of the plurality of channels, calculating using a hardware processor an increase in power that will be used by that channel if it transmits a symbol; selecting one of the plurality of channels with the smallest increase in power using the hardware processor; and allocating the symbol to the one of the plurality of channels using the hardware processor.

In some embodiments, systems for selecting numbers of symbols to be transmitted on a plurality of channels are provided, the systems comprising: at least one hardware processor that: for each of the plurality of channels, calculates an increase in power that will be used by that channel if it transmits a symbol; selects one of the plurality of channels with the smallest increase in power; and allocates the symbol to the one of the plurality of channels.

In some embodiments, non-transitory computer-readable media containing computer-executable instructions that, when executed by a processor, cause the processor to perform a method for selecting numbers of symbols to be transmitted on a plurality of channels are provide, the method comprising: for each of the plurality of channels, calculating an increase in power that will be used by that channel if it transmits a symbol; selecting one of the plurality of channels with the smallest increase in power; and allocating the symbol to the one of the plurality of channels.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a generalized schematic diagram of an example of a distributed storage system in accordance with some embodiments of the disclosed subject matter.

FIG. 2 is a generalized schematic diagram of an example of a data collector and a storage node of FIG. 1 that can be used in accordance with some embodiments of the disclosed subject matter.

FIG. 3 is a flow chart of an example of a process for partial downloading in accordance with some embodiments of the disclosed subject matter.

FIGS. 4-6 are flow charts of an example of processes for determining whether a condition is sufficient for μ-reconstructability for the minimum-storage regenerating (MSR) point in accordance with some embodiments of the disclosed subject matter.

FIG. 7 is a flow chart of an example of a recursive symbol selection process for a partial downloading scheme for the MSR point in accordance with some embodiments of the disclosed subject matter.

FIG. 8 is an illustrative example of data reconstruction for the coding scheme at the minimum-bandwidth regenerating (MBR) point in accordance with some embodiments of the disclosed subject matter.

FIG. 9 is a flow chart of an example of a process for a partial downloading scheme that includes performing a backward reconstruction in accordance with some embodiments of the disclosed subject matter.

FIG. 10 is a flow chart of an example of a symbol selection process for a partial downloading scheme for the MBR point in accordance with some embodiments of the disclosed subject matter.

FIG. 11A is a flow chart of an example of a process for minimizing power during reconstruction transmission in accordance with some embodiments of the disclosed subject matter.

FIG. 11B is a flow chart of an example of a process for adjusting a transmission allocation for the MSR point in accordance with some embodiments of the disclosed subject matter.

FIG. 11C is a flow chart of an example of a process for adjusting a transmission allocation for the MBR point in accordance with some embodiments of the disclosed subject matter.

FIG. 12 is a flow chart of an example of a process for minimizing power during regeneration transmission in accordance with some embodiments of the disclosed subject matter.

### DETAILED DESCRIPTION

In accordance with various embodiments, as described in more detail below, mechanisms (e.g., systems, methods, media, etc.) for partial downloading in wireless distributed networks are provided. Such mechanisms can be used in a variety of applications. For example, the mechanisms can be used to retrieve and/or reconstruct data stored in a distributed storage system. As another example, the mechanisms can be used to perform node regeneration in some embodiments in which one or more storage nodes in a distributed storage system fail.

In some embodiments, the mechanisms can be implemented in a distributed storage network including a data collector and multiple storage nodes. The data collector can communicate with one or more of the storage nodes through any suitable communication channels. For example, in some embodiments, the storage nodes can be connected to the data collector through multiple orthogonal wireless channels.

In some embodiments, the mechanisms can store data in the storage nodes in a distributed manner. For example, a data block containing M symbols can be stored in S storage nodes. In a more particular example, each of the S storage nodes can store α symbols that can be used to reconstruct the data block. In some embodiments, each of the α symbols can be generated from one or more of the M symbols based on a set of linear combination coefficients.

In some embodiments, the data collector can reconstruct the data block from one or more of the storage nodes. For example, the data reconstruction can be performed based on a partial downloading scheme. In a more particular example, the data collector can download a suitable set of symbols from each storage node. In some embodiments, the data collector can determine the number of symbols to be downloaded from each channel and storage node based on suitable channel and power allocation schemes. In some embodiments, the data collector can also select the set of symbols to be downloaded based on one or more suitable symbol selection schemes. For example, the set of symbols can be selected from α symbols stored in a given storage node based on linear dependences among the symbols. As another example, the set of symbols can be selected based on a recursive algorithm. As another example, the data reconstruction can be performed based on a full downloading scheme. In a more particular example, the data collector can download α symbols for a subset of the storage nodes.

In some embodiments, when a storage node fails or leaves the distributed storage system, the mechanisms can regenerate the symbols stored in the failed node (e.g., α symbols) and create a new storage node. For example, the symbols can be regenerated by downloading a suitable number of symbols from one or more of the surviving storage nodes. In some embodiments, for example, the new storage node can download β symbols from each of a set of d surviving storage nodes. In such an example, a total number of dβ symbols can be downloaded from the surviving storage nodes for node regeneration.

In some embodiments, these mechanisms can be implemented in a wireless cloud storage network, where a large number of users need to download data symbols with limited bandwidth. In such a network, a large amount of data that needs to be downloaded by a mobile device can be obtained by partially downloading data symbols from storage nodes for data reconstruction and node regeneration. This can be performed, for example, while conserving power and bandwidth of the wireless cloud storage network.

It should be noted that, as used herein, for a family of matrices {H⁽ⁱ⁾} [symbol] with the same number of rows, [symbol] [symbol] [H⁽ⁱ⁾, iε [symbol] ] can be the matrix obtained by horizontally concatenating H⁽ⁱ⁾ for iε [symbol] , e.g., [symbol] =[H⁽¹⁾|H⁽²⁾] for [symbol] ={1,2}. In some embodiments, H₀ [symbol] H can denote that H₀ is a submatrix of H by extracting columns of H. In some embodiments, H₀⊂H can denote that H₀ [symbol] H and H₀≠H. In some embodiments, for H₀ [symbol] H, H\H₀ can be the submatrix of H that includes all columns of H but not in H₀. In some embodiments, span(H) can be the space spanned by the columns of H. In some embodiments, for two spaces Q₀ and Q, Q₀ [symbol] Q can denote that Q₀ is a subspace of Q. In some embodiments, Q₀⊂Q can denote that Q₀ [symbol] Q and Q₀≠Q. In some embodiments, if H₀ [symbol] H, span(H₀) [symbol] span(H). In some embodiments, rank(H) can be the column rank of the matrix H that equals to the dimension of space span(H).

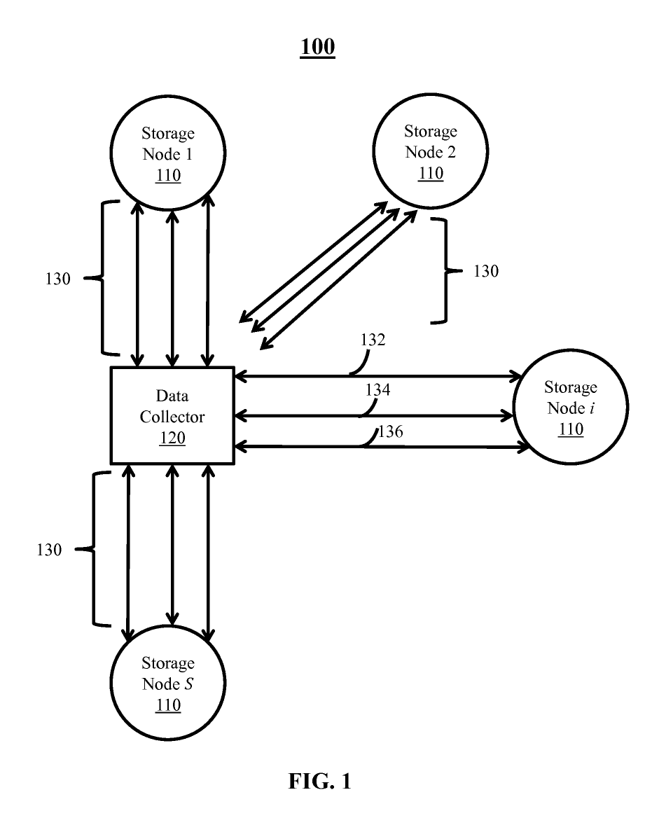

Turning to FIG. 1, a generalized schematic diagram of an example 100 of a distributed storage system in accordance with some embodiments of the disclosed subject matter is shown.

As illustrated, system 100 can include multiple storage nodes 110, each of which is capable of storing a suitable amount of data. For example, system 100 can store a data block in S storage nodes 110 in a distributed manner. In a more particular example, the data block can contain M symbols that can be denoted as:

s=[s₁,s₂, . . . ,s_{M}]^{T} (1)

In such an example, each storage node 100 can store α symbols that are generated based on one or more of the M symbols. In some embodiments, each of the α symbols may be a packet of subsymbols in a field GF(q) and may contain B bits. More particularly, for example, each storage node 110 (e.g., storage node i) can store a linear combination of data symbols that can be denoted as:

m⁽ⁱ⁾=[m₁⁽ⁱ⁾, . . . ,m_{α}⁽ⁱ⁾], (2)

where i denotes the index of the storage nodes. In some embodiments, each of the symbols given in Equation 2 can be obtained based on a set of the M symbols as follows:

mⱼ⁽ⁱ⁾=Σₖ₌₁^{M}hₖⱼ⁽ⁱ⁾sₖ=s^{T}hⱼ⁽ⁱ⁾, 1≦j≦α, (3)

where the coefficients hⱼ⁽ⁱ⁾=[h₁ⱼ⁽ⁱ⁾, h₂ⱼ⁽ⁱ⁾, . . . , h_{Mj}⁽ⁱ⁾]^{T}εGF(q)^{M}, for 1≦j≦α. In some embodiments, an encoding matrix can be defined as follows:

H⁽ⁱ⁾ [symbol] [h₁ⱼ⁽ⁱ⁾,h₂ⱼ⁽ⁱ⁾, . . . ,h_{Mj}⁽ⁱ⁾]εGF(q)^{M×α}. (4)

In some embodiments, equation (2) can be converted into the following format based on equations (3) and (4):

(m⁽ⁱ⁾)^{T}=s^{T}H⁽ⁱ⁾ for iεS. (5)

As shown in FIG. 1, system 100 can also include one or more data collectors 120. In some embodiments, data collector 120 can perform data reconstruction by reconstructing the data stored in system 100 based on a suitable set of symbols stored in storage nodes 110. For example, to reconstruct the data block defined in equation (1), data collector 120 can download a set of symbols from one or more of storage nodes 110. Data collector 120 can then reconstruct the original data contained in the data block based on the encoding matrices associated with the storage nodes (e.g., {H⁽ⁱ⁾}_{iεS}).

In a more particular example, data collector 120 can perform data reconstruction based on a partial downloading scheme by downloading a set of symbols from one or more of storage nodes 110. More particularly, for example, data collector 120 can perform channel and power allocation and determine the number of symbols downloaded from each storage node 110. Data collector 120 can then download a suitable number of symbols from each storage node 110 (e.g., downloading μᵢ symbols from a storage node i).

In another more particular example, data collector 120 can download all symbols required to perform data reconstruction from a set of storage nodes 110. More particularly, for example, data collector 120 can download α symbols from each of K storage nodes 110, wherein K is not greater than S. In such an example, a total number of Kα symbols can be downloaded from K storage nodes 110.

In some embodiments, data collector 120 can be connected to each storage node 110 through one or more communication channels 130 that can include a command channel 132, a data channel 134, a feedback channel 136, etc. Any suitable information can be transmitted through communication channels 130 to facilitate data reconstructions and/or node regeneration. For example, in some embodiments, data collector 120 can communicate particular information with each storage node 110 through one or more communication channels. In a more particular example, a storage node 110 can transmit an encoding matrix associated with the storage node to data collector 120 through command channel 132. In another more particular example, a storage node 110 can transmit one or more data symbols to data collector 120 through data channel 134 (e.g., an orthogonal frequency-division multiple access channel or OFDMA channel). In yet another more particular example, data collector 120 can transmit information about the number and/or the identities of the symbols to be downloaded from one or more storage nodes 110 through feedback channel 136.

In some embodiments, system 100 can regenerate the data stored in a failed storage node. For example, in some embodiments in which a storage node 110 that stores a symbols fails or leaves system 100, system 100 can regenerate the α symbols and create a new storage node. In a more particular example, the α symbols can be regenerated by downloading a suitable number of symbols from one or more of the surviving storage nodes. In some embodiments, for example, the new storage node can download symbols from each of a set of d surviving storage nodes. In such an example, a total number of γ=dβ symbols can be downloaded from the surviving storage nodes for node regeneration. In some embodiments, upon the creation of the new storage node, data collector 120 can reconstruct the data stored in system 100 by downloading Kα symbols from K storage nodes 110 as described above.

In some embodiments, the amount of symbols downloaded for data reconstruction (e.g., Kα) and the amount of symbols downloaded for node regeneration (e.g. γ=dβ) can be described using an optimal tradeoff curve. For example, the optimal tradeoff curve may have a minimum-storage regenerating (MSR) point corresponding to coding schemes with the best efficiency for data reconstruction (e.g., Kα=M). As another example, the optimal tradeoff curve may have a minimum-bandwidth regenerating (MBR) point corresponding to coding schemes with the best efficiency for node regeneration (e.g., dβ=α).

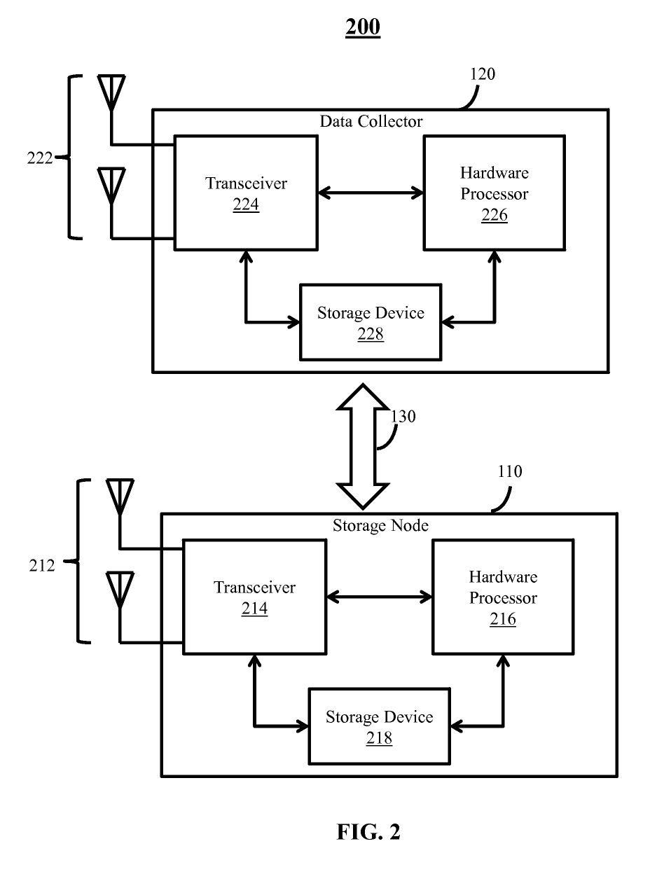

Turning to FIG. 2, a generalized schematic diagram of an example of a data collector and a storage node of FIG. 1 that can be used in accordance with some embodiments of the disclosed subject matter is shown.

As illustrated, storage node 110 can include one or more antennas 212, a transceiver 214, a hardware processor 216, a storage device 218, and/or any other suitable components. In some embodiments, transceiver 214 can transmit data symbols, linear combination coefficients, and/or other suitable information to data collector 120 through antennas 212. Transceiver 214 can also receive feedback signals containing information about one or more symbols to be downloaded from storage node 110 through antennas 212. In some embodiments, transceiver 214 can pass the feedback signals to hardware processor 216. Hardware processor 216 can then process the feedback signals and identify the symbols to be transmitted to data collector. In some embodiments, storage node 110 can store suitable data in storage device 218. For example, storage device 218 can store a data symbols, a set of linear combination coefficient (e.g., an encoding matrix) associated with the data symbols, and/or other suitable data

As shown, data collector 120 can include one or more antennas 222, a transceiver 224, a hardware processor 226, a storage device 228, and/or any other suitable components. In some embodiments, transceiver 224 can receive suitable data and/or commands transmitted from one or more storage nodes 110 through one or more antennas 222. The data and/or commands can then be stored in storage device 228 and/or passed to hardware processor 226. Hardware processor 226 can perform channel estimation, wireless resource allocation, and/or other suitable functions based on the received data, commands, and/or other suitable information. In some embodiments, hardware processor 226 can generate one or more feedback signals containing information about the results of the channel estimation and/or wireless resource allocation. In some embodiments, the feedback signals can be transmitted to one or more storage nodes 110 through transceiver 224 and antenna(s) 222.

In some embodiments, storage node 110 and data collector 120 can be implemented in any suitable devices. For example, they can be implemented in mobile computers, mobile telephones, mobile access cards, wireless routers, wireless access points and/or any other suitable wireless devices.

In some embodiments, each of transceivers 214 and 224 can include both a receiver and a transmitter in some embodiments. In some embodiments, each transceiver can include one or more multi-input multi-output (MIMO) transceivers where each includes multiple antennas (e.g., such as two transmit antennas and four receive antennas (some of which may also be transmit antennas)).

In some embodiments, each of hardware processors 216 and 226 can include any suitable hardware processor, such as a microprocessor, a micro-controller, digital signal processor, dedicated logic, and/or any other suitable circuitry.

In some embodiments, each of storage devices 218 and 228 can include any suitable circuitry that is capable of storing data symbols, linear combination coefficients, feedback signals, computer readable instructions, etc. For example, each of storage devices 218 and 228 can include a hard drive, a solid state storage device, a removable storage device, etc.

It should be noted that storage node 110 and data collector 120 can include any other suitable components. For example, in some embodiments, each of storage node 110 and data collector 120 can include a modulator, a demodulator, etc.

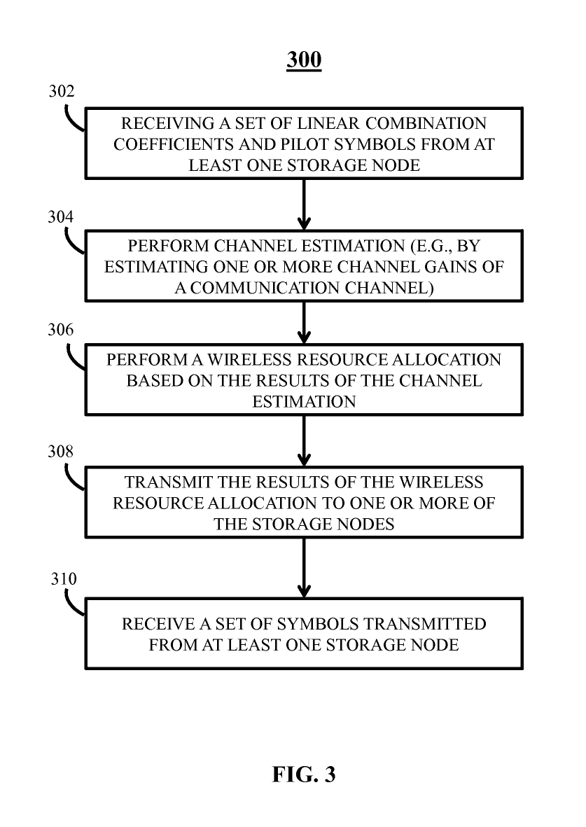

Turning to FIG. 3, a flow chart of an example 300 of a process for partial downloading for wireless distributed storage networks in accordance with some embodiments of the disclosed subject matter is shown. In some embodiments, process 300 can be implemented in a data collector (e.g., data collector 120 as illustrated in FIGS. 1 and 2).

As illustrated, process 300 can start by receiving a set of linear combination coefficients and pilot symbols from at least one storage node at 302. The set of linear combination coefficients can contain any suitable information about one or more symbols stored in the storage node. For example, the combination coefficients can include one or more encoding matrices as defined in equation (4). In a more particular example, a storage node can transmit an encoding matrix H⁽ⁱ⁾ that is associated with the storage node through a command channel. Additionally, the storage node can transmit one or more pilot symbols to the data collector through a data channel.

Next, at 304, process 300 can perform a channel estimation on one or more communication channels. For example, the data collector can estimate one or more channel gains of a communication channel that connects a particular storage node to the data collector. In a more particular example, channel gains {gⱼ⁽ⁱ⁾} [symbol] can be estimated for the storage node, where gⱼ⁽ⁱ⁾ denotes the complex gain of channel j from storage node i (iεS) to the data collector. In some embodiments, the channel gains can be estimated based on any suitable models. For example, the channel gains between the data collector and a particular storage node can be modeled by a complex Gaussian random variable [symbol] (0, d⁻²), where d represents the distance between the data collector and the storage node.

At 306, process 300 can perform a wireless resource allocation based on the results of the channel estimation. For example, the data collector can estimate the number of symbols that can be transmitted from a particular storage node to the data collector over a particular communication channel based on the estimated channels gains. In a more particular example, the data collector can be connected to S storage nodes via N orthogonal wireless channels [symbol] ={1, 2, . . . , N}. In some embodiments, each of the wireless channels can have a suitable bandwidth (e.g., a bandwidth W) and a suitable duration (e.g., a duration T). In such an example, the number of symbols that can be transmitted from storage node i (iεS) to the data collector over channel j (jε [symbol] ) can be estimated as follows:

$$c ( {\vert {g}_{j}^{( i )} \vert}^{2} {P}_{j} ) = \frac{WT}{B} {log}_{2} ( 1 + k \frac{\vert {g}_{j}^{( i )} \vert {P}_{j}}{{σ}^{2}} ) , \qquad ( 6 )$$

where Pⱼ denotes the transmission power of channel j; σ² is the power of background noise; W denotes the bandwidth of channel j; T denotes the duration of channel j; and k<1 accounts for the rate loss due to the practical modulation and coding, compared with the ideal case of Gaussian signaling and infinite-length code. In some embodiments, the transition power of a communication channel can be a function of the amount of information transmitted through the communication channel.

In some embodiments, data can be transmitted over a channel in unit of a symbol. For example, one or multiple symbols can be transmitted over the channel. In such an example, wireless resources (e.g., power, bandwidth, etc.) can be allocated to minimize the total transmission power of N channels while achieving successful data reconstruction.

At 308, process 300 can transmit the results of the wireless resource allocation to one or more of the storage nodes. In some embodiments, the results of the wireless resource allocation can be transmitted in any suitable manner. For example, the data collector can generate a feedback signal containing information about the number of the symbols and/or the identities of the symbols to be downloaded from a particular storage node. The data collector can then transmit the feedback signal to the particular storage node through a suitable communication channel (e.g., a feedback channel that connects the data collector to the particular storage node).

At 310, process 300 can receive a set of symbols transmitted from at least one storage node. For example, a storage node can transmit a set of symbols to the data collector based on the feedback signal transmitted from the data collector. In a more particular example, in response to receiving the feedback signal, the storage node can identify the symbols chosen by the data collector by wireless resource allocation and transmit the identified symbols to the data collector through a suitable communication channel (e.g., a data channel that connects the data collector to the storage node).

As described herein, a portion of the symbols stored in each storage node can be downloaded. For example, a data collector can use a partial downloading scheme that downloads a portion of the symbols from any suitable storage node. In a more particular example, for storage nodes and a data collector linked by wireless channels, the data collector (e.g., data collector 120 as illustrated in FIGS. 1 and 2) can download symbols in a roughly even manner from the storage nodes such that the total number of downloaded symbols is equal to the number of data symbols to be reconstructed.

It should be noted that the reconstructability of the original data can be considered when performing such a partial downloading scheme. For example, for iεS, let μᵢ be the number of symbols downloaded from storage node i. Since μᵢ≦∝, it can be assumed that the downloaded symbols are linear combinations of the symbols in node i given by s^{T}H⁽ⁱ⁾A⁽ⁱ⁾, where A⁽ⁱ⁾ is an α×μᵢ matrix. The data s can then be reconstructed from the downloaded symbols s^{T}[H⁽ⁱ⁾A⁽ⁱ⁾]_{iεS} if:

rank([H⁽ⁱ⁾A⁽ⁱ⁾]_{iεS})=M (7)

For each iεS, the matrix A⁽ⁱ⁾ can be a full column rank, since otherwise at least one downloaded symbol can be expressed as a linear combination of other symbols downloaded from the same storage node, which means this symbol is redundant and should be removed to reduce the downloading bandwidth.

However, it should be noted that the search for the linear combination matrices {A⁽ⁱ⁾}_{iεS} that satisfy the above-mentioned equation (7) may be computationally prohibitive. While it may be simpler to directly download the stored symbols from each storage node without performing such a linear combination, it can be determined whether there is a loss in optimality. That is, for some symbols {μᵢ}_{iεS}, it can determined whether the above-mentioned equation (7) can be satisfied by performing linear combination but cannot be satisfied by simply downloading the stored symbols without linear combination. It has been determined that, in terms of the number of symbols downloaded from the storage nodes, downloading the symbols stored in the storage nodes directly and downloading their linear combinations are equivalent in some embodiments. This can be represented as follows:
If there exists α×μᵢ matrices A⁽ⁱ⁾ for iεS such that the above-mentioned equation (7) is satisfied, then there exist M×μᵢ submatrices H̅⁽ⁱ⁾ [symbol] H⁽ⁱ⁾, iεS, such that the matrix H̅^{S} [symbol] [ H̅⁽ⁱ⁾]_{iεS} is of rank M.

Accordingly, given μ=[μ₁, μ₂, . . . , μ_{S}], μᵢε{0, 1, . . . , α} for 1≦i≦S, the data can be μ-reconstructable if it can be reconstructed via downloading μᵢ symbols from storage node i for iεS, which is equivalent to that there exist M×μᵢ submatrices H̅⁽ⁱ⁾ [symbol] H⁽ⁱ⁾, iεS, such that the matrix H̅^{S} [symbol] [ H̅⁽ⁱ⁾]_{iεS} is of rank M.

In some embodiments, a portion of the symbols in a storage node for data reconstruction can be downloaded at the minimum-storage regenerating (MSR) point or at the minimum-bandwidth regenerating (MBR) point. This can be performed, for example, by the data collector.

Generally speaking, to analyze the μ-reconstructability at either the MSR or the MBR point, one or more sufficient conditions on {μᵢ}_{iεS} such that data can be reconstructed (e.g., by the data collector 120 illustrated in FIGS. 1 and 2) via downloading μᵢ symbols from storage node i, iεS can be determined. In response, a partial downloading scheme given a set {μᵢ}_{iεS} that satisfied this condition can be provided.

In some embodiments, the data can be reconstructed by downloading a portion of the symbol from any suitable storage nodes at the MSR point. In this example, the data collector (e.g., data collector 120 as illustrated in FIGS. 1 and 2) can use a partial downloading scheme such that the number of downloaded symbols should be no less than the total number of data symbols to be reconstructed. This can be represented by:

Σ_{iεS}μᵢ≧M (8)

It should be noted that the μ-reconstructability can be considered for all coding schemes satisfying the constraint of the MSR point that Kα=M in some embodiments. In some embodiments, since, for any size-K subset [symbol] [symbol] , the data s can be reconstructed from the M downloaded symbols s^{T}[H⁽ⁱ⁾]_{iεS}, the square matrix [H⁽ⁱ⁾]_{iεR} is of rank M. Thus, in such embodiments, for any subset [symbol] [symbol] S with | [symbol] |≦K, the columns of matrix [H⁽ⁱ⁾]_{iεR} are linearly independent.

Accordingly, Σ_{iεS}μᵢ≧M, which states that the number of downloaded symbols should be no less than the total number of data symbols to be reconstructed, can also be a sufficient condition for μ-reconstructability for the MSR point.

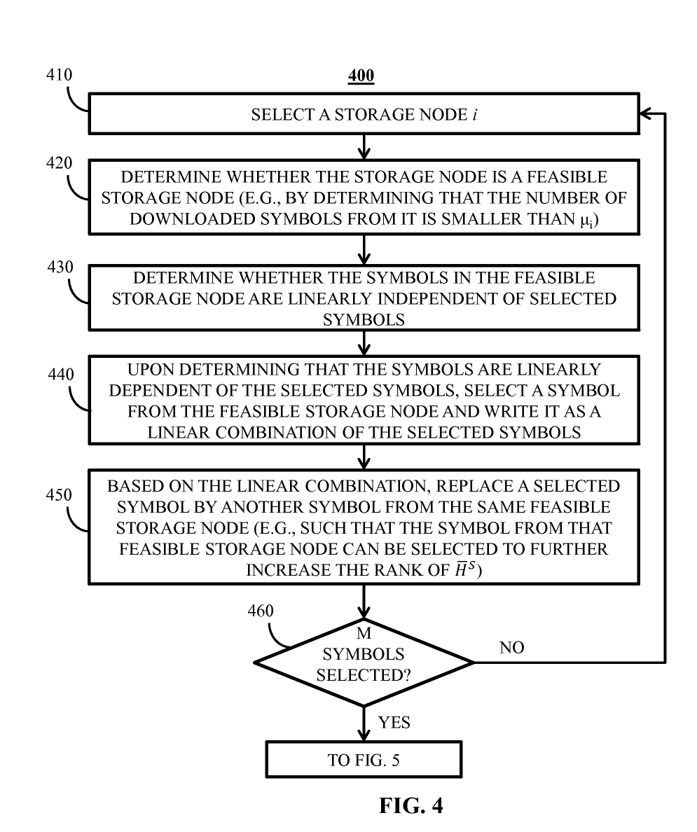

In some embodiments, it can be determined or tested whether a condition is sufficient for μ-reconstructability for the MSR point. FIG. 4 shows an illustrative example of a process for determining whether a condition is sufficient for μ-reconstructability for the MSR point in accordance with some embodiments of the disclosed subject matter. It should be noted that, in process 400 of FIG. 4 and any other process or method described herein, some steps can be added, some steps can be omitted, the order of the steps can be re-arranged, and/or some steps can be performed simultaneously.

Generally speaking, to determine whether Σ_{iεS}μᵢ≧M is a sufficient condition for μ-reconstructability for the MSR point, process 400 selects μᵢ symbols s^{T} H̅⁽ⁱ⁾ from storage node i for any {μᵢ}_{iεS} satisfying Σ_{iεS}μᵢ=M, where H̅⁽ⁱ⁾ is an M×μᵢ submatrix of H⁽ⁱ⁾, iεS such that H̅^{S}=[H⁽ⁱ⁾]_{iεS} is of rank M. Process 400 continues to select symbols that are linearly independent of the selected symbols until M symbols have been selected.

Process 400 begins at 410 by selecting a storage node i. At 420, process 400 determines whether the selected storage node is a feasible storage node. In some embodiments, a storage node i can be considered feasible if the number of downloaded symbols from it is smaller than μᵢ.

Upon determining that the storage node is a feasible storage node at 420, process 400 can determine whether all of the symbols in the feasible storage node are linearly independent of the selected symbols at 430. Upon determining that the symbols in the feasible storage node are linearly independent of the selected symbols, a symbol from the feasible storage node can be selected and written as a linear combination of the selected symbols at 440. Based on the linear combination, a selected symbol can be replaced with another symbol from the same storage node such that the symbol from that feasible storage node can be selected to further increase the rank of H̅^{S} at 450.

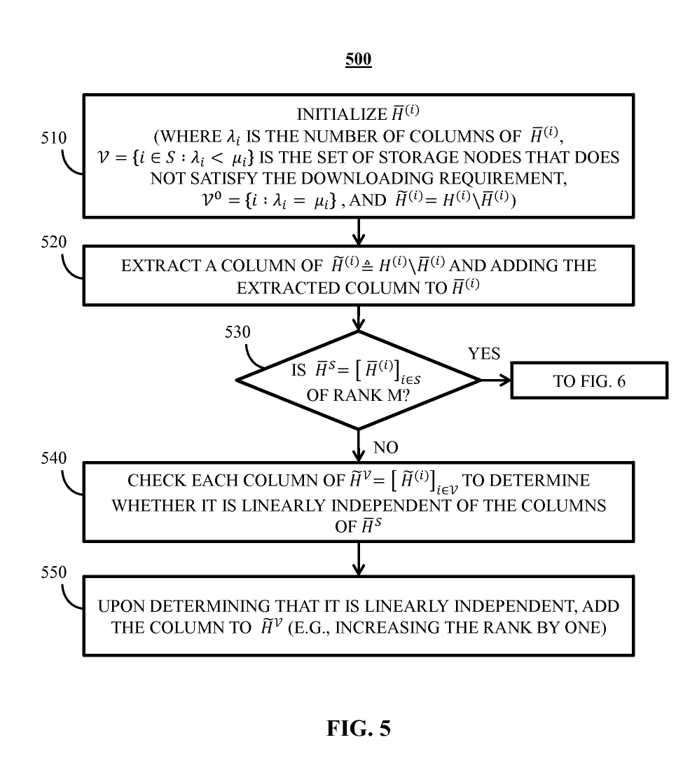

Process 400 can determine whether M symbols have been selected at 460. If M symbols have not been selected, process 400 can return to 410 and can continue to select symbols that are linearly independent of the selected symbols from one or more storage nodes. Upon selecting M symbols, process 400 can turn to process 500 of FIG. 5.

As shown in FIG. 5, process 500 begins at 510 by initializing H̅⁽ⁱ⁾ as null matrices for iεS. It should be noted that, in the selection process, let λᵢ be the number of columns of H̅⁽ⁱ⁾ (the number of symbols already selected from storage node i). It should also be noted that V={iεS:λᵢ<μᵢ} is the set of storage nodes that does not satisfy the downloading requirement, V⁰={i:λᵢ=μᵢ}, and \tilde{H}₍ᵢ₎=H⁽ⁱ⁾\ H̅⁽ⁱ⁾ for iεS.

At 520, process 500 can extract a column of \tilde{H}⁽ⁱ⁾ [symbol] H⁽ⁱ⁾\ H̅⁽ⁱ⁾ and add the extracted column to H̅⁽ⁱ⁾ for some iεV [symbol] {iεS:λᵢ<μᵢ}. This extraction and addition can continue until H̅^{S}=[H⁽ⁱ⁾]_{iεS} is of rank M.

When it is determined that rank ( H̅^{S})<M at 530, process 500 can check each column of \tilde{H}^{V}=[\tilde{H}⁽ⁱ⁾]_{iεV} to determine whether it is linearly independent of the columns of H̅^{S} at 540. Upon determining that the column is linearly independent, process 500 can add the column to \tilde{H}^{V} and, thus, increase the rank by one at 550.

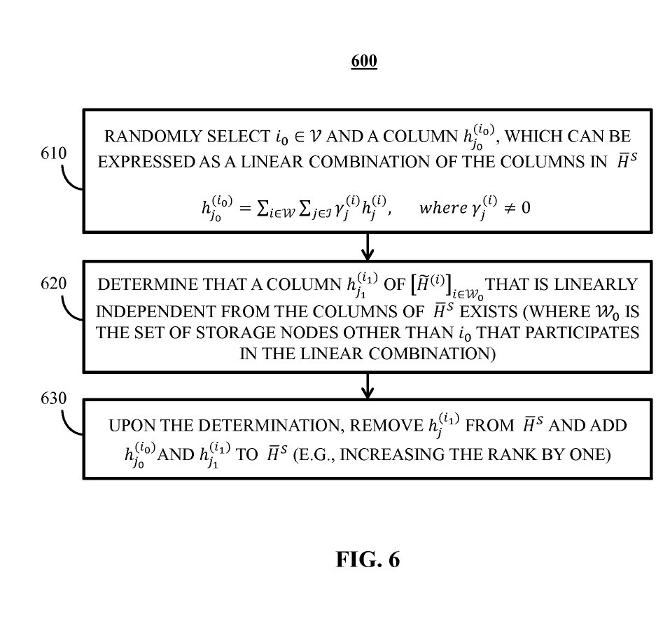

Otherwise, process 500 can turn to process 600 of FIG. 6.

Process 600 begins by randomly selecting some i₀εV and a column

$${h}_{{j}_{0}}^{( {i}_{0} )}$$

of \tilde{H}⁽ⁱ^{₀}⁾. This can, for example, be expressed as a linear combination of the columns in H̅^{S}. For example:

$${h}_{{j}_{0}}^{( {i}_{0} )} = {\sum }_{i ∈ w} {\sum }_{j ∈ 𝒥} {y}_{j}^{( i )} {h}_{j}^{( i )} , \\ {y}_{j}^{( i )} \neq 0 \qquad ( 9 )$$

where [symbol] is the set of storage nodes, and [symbol] ᵢ [symbol] {1, 2, . . . , α}, for each iε [symbol] , is the set of column indices of H̅⁽ⁱ⁾ that participate in the linear combination representation of hⱼ_{₀}⁽ⁱ^{₀}⁾ shown above in (9). It should be noted that [symbol] ₀= [symbol] \{i₀} is the set of storage nodes other than i₀ that participates in the above-mentioned linear combination of (9).

At 620, process 600 determines that a column

$${h}_{{j}_{1}}^{( {i}_{1} )}$$

of [\tilde{H}⁽ⁱ⁾] [symbol] exists mat is linearly independent from the columns of H̅^{S}. Again, it should be noted that a property of the MSR point is that the columns of [symbol] are linearly independent for any | [symbol] |≦K and rank ( [symbol] )=M. Accordingly, span( [symbol] )=Q=GF(q)^{M} for any | [symbol] |≧K. Since the above-mentioned linear combination (9) involves the columns from matrices H̅⁽ⁱ⁾ for iε [symbol] ∪{i₀}, | [symbol] ∪{i₀}|≧K+1 and | [symbol] ₀|=| [symbol] \{i₀}|≧K, and thus:

Q=span(H^{W}^{₀}) [symbol] span([ H̅^{S\W}^{₀}|H^{W}^{₀}])=span([ H̅^{S}|\tilde{H}^{W}^{₀}])

Accordingly, rank([ H̅^{S}|\tilde{H}^{W}^{₀}])=M. It should be noted that, by assuming that rank ( H̅^{S})<M, it follows that there exists a column

$${h}_{{j}_{1}}^{( {i}_{1} )}$$

of \tilde{H}^{W}^{₀} that is linearly independent from the columns of H̅^{S}.

It should be noted that, for the linear combination shown above in (9) in some embodiments, replacing a column

$${h}_{{j}_{1}}^{( {i}_{1} )}$$

for a jε [symbol] ₁ with

$${h}_{{j}_{0}}^{( {i}_{0} )}$$

does not change span ( H̅^{S}), but provides space for

$${h}_{{j}_{1}}^{( {i}_{1} )} ,$$

which increases the rank of H̅^{S} by one. Accordingly, process 600 removes

$${h}_{{j}_{1}}^{( {i}_{1} )}$$

from H̅^{S} and then adds

$${h}_{{j}_{0}}^{( {i}_{0} )} and {h}_{{j}_{1}}^{( {i}_{1} )}$$

to H̅^{S}, thereby increasing the rank of H̅^{S} by one.

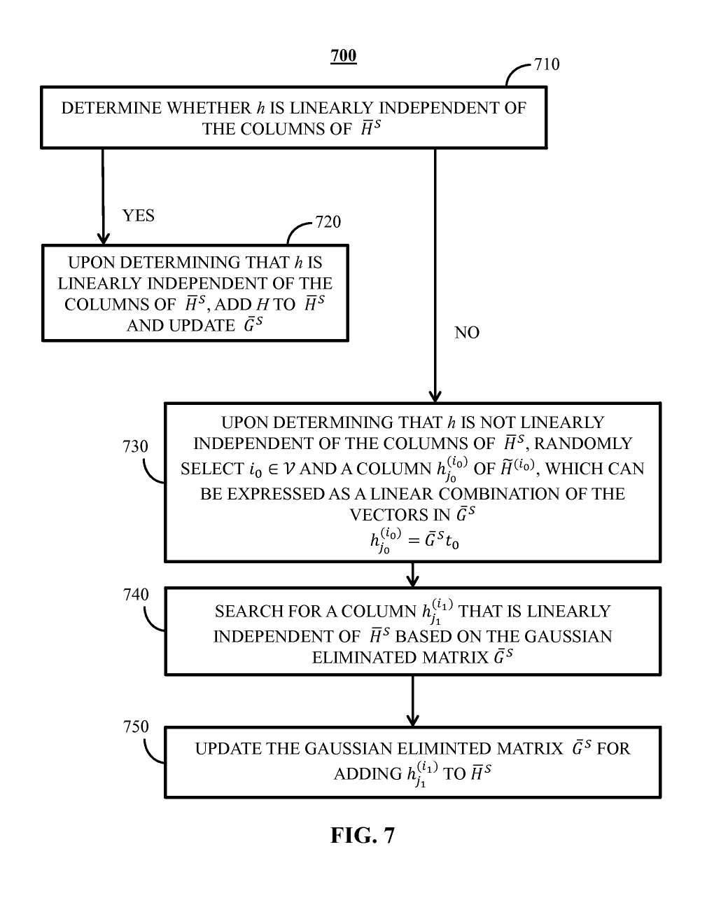

In some embodiments, a symbol selection process for a partial downloading scheme at the MSR point can be provided. For example, FIG. 7 shows an illustrative example of a recursive symbol selection process for a partial downloading scheme at the MSR point in accordance with some embodiments of the disclosed subject matter. It should be noted that Λ can be used to represent the number of columns of H̅^{S} and G̅^{S} can be used to represent the Gaussian elimination representation of H̅^{S} via column transformation ( G̅^{S}= H̅^{S}T).

At 710, process 700 can determine whether h is linearly independent of the columns of H̅^{S}. At 720, upon determining that h is linearly independent of the columns of H̅^{S}, process 700 can add H to H̅^{S} and, accordingly, update G̅^{S}.

Alternatively, upon determining that h is not linearly independent of the columns of H̅^{S}, process 700 can randomly select i₀εV and a column

$${h}_{{j}_{0}}^{( {i}_{0} )}$$

of \tilde{H}⁽ⁱ^{₀}⁾, which can be expressed as a linear combination of the vectors in G̅^{S}. For example:

$${h}_{{j}_{0}}^{( {i}_{0} )} = {\overline{G}}^{S} {t}_{0} .$$

Allowing H̅^{S}= G̅^{S}T₀ to represent the Gaussian elimination procedure for H̅^{S},

$${h}_{{j}_{0}}^{( {i}_{0} )}$$

can be represented as:

$${h}_{{j}_{0}}^{( {i}_{0} )} = {\overline{H}}^{S} {T}_{0}^{- 1} {t}_{0}$$

It should be noted that this is an explicit representation of the equation

$${h}_{{j}_{0}}^{( {i}_{0} )} = {\sum }_{i ∈ w} {\sum }_{j ∈ 𝒥} {y}_{j}^{( i )} {h}_{j}^{( i )} , \\ {y}_{j}^{( i )} \neq 0.$$

Referring back to FIG. 7, process 700 can search for a column

$${h}_{{j}_{1}}^{( {i}_{1} )}$$

this is linearly independent of H̅^{S} based on the Gaussian eliminated matrix G̅^{s}. It should be noted that, since replacing

$${h}_{j}^{( {i}_{1} )} with {h}_{{j}_{0}}^{( {i}_{0} )}$$

does not change the spanned space and thus the Gaussian eliminated matrix G̅^{S}, process 700 only needs to update the Gaussian eliminated matrix G̅^{S} for adding

$${h}_{{j}_{1}}^{( {i}_{1} )}$$

### to H̅^{S}.

In some embodiments, the data can be reconstructed by downloading a portion of the symbols from any suitable storage nodes at the MBR point. For example, the data collector (e.g., data collector 120 as illustrated in FIGS. 1 and 2) can use a partial downloading scheme that downloads a portion of the symbols from any suitable storage nodes at the MBR point.

A data block of:

$$M = \frac{K ( K + 1 )}{2} + K ( d - K )$$

symbols can be stored among S storage nodes, where each node stores α=d symbols. The M symbols can be represented using the following d×d symmetric matrix:

$$B = [ \begin{matrix}{B}^{( 1 )} & {B}^{( 2 )} \\ {( {B}^{( 2 )} )}^{T} & 0\end{matrix} ]$$

where B⁽¹⁾ is a K×K symmetric matrix storing

$$K \frac{( K + 1 )}{2}$$

symbols and B⁽²⁾ is a K×(d−K) matrix storing K(d−K) symbols. For encoding, the matrix B is premultiplied by an S×d Vandermonde matrix given by Ψ, and each node iεS stores the d symbols corresponding to the i^{th} row of ψᵢB, where ψᵢ is the i^{th} row of Ψ.

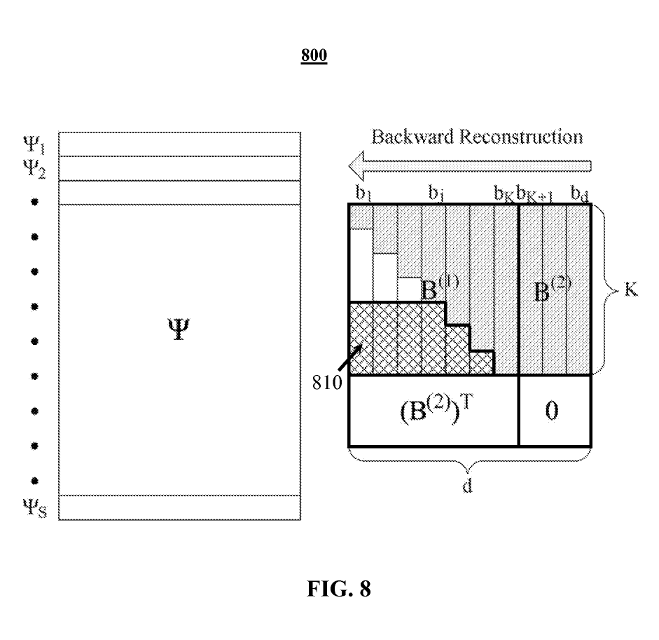

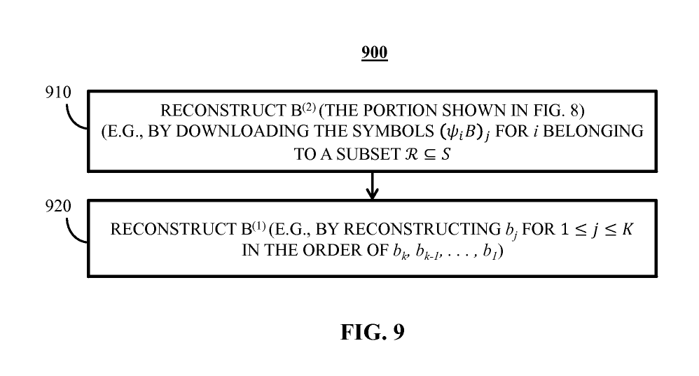

In some embodiments, a partial downloading scheme for reconstructing data at the MBR point based on the above coding scheme is provided. As shown in FIG. 8, since the matrix B⁽¹⁾ is symmetric, the data symbols in B⁽²⁾ and in the upper triangular part of B⁽¹⁾ can be decoded. As also shown in FIG. 8, the data symbol can be divided into d columns {bⱼ}_{1≦j≦d}, where bⱼ for 1≦j≦K are in the upper triangular part of B⁽¹⁾, and bⱼ for K+1≦j≦d are the columns of B⁽²⁾. The data can be reconstructed in the backward order of b_{d}, b_{d-1}, . . . , b₁. It should be noted that the number of symbols in bⱼ, 1≦j≦d, can be given by min {j, K} [symbol] θⱼ. Let (ψᵢB)ⱼ be the j^{th} symbol in storage node i which is the product of ψᵢ and the j^{th} column of B.

As shown in the example flow diagram of FIG. 9, a partial downloading scheme that performs a backward reconstruction process 900 is provided in accordance with some embodiments of the disclosed subject matter.

At 910, process 900 can begin by reconstructing B⁽²⁾ of matrix B. Referring back to FIG. 8, to reconstruct bⱼ, the data collector can download the symbols (ψᵢB)ⱼ for i belonging to a subset [symbol] [symbol] S, here the size | [symbol] ⱼ|≧K=θⱼ. Since Ψ is a Vandermonde matrix, bⱼ can be reconstructed with K downloaded symbols.

At 920, process 900 can then reconstruct B⁽¹⁾ of matrix B. This can be done, for example, by reconstructing bⱼ for 1≦j≦K in the order of bₖ, bₖ₋₁, . . . , b₁. Referring back to FIG. 8, when reconstructing bⱼ since bₗ for j<l≦K have been reconstructed and B⁽¹⁾ is symmetric, the part of B⁽¹⁾ shown in area 802 is known from the previous reconstruction. Then, as B⁽²⁾ has been reconstructed in 910 and thus is known, reconstructing bⱼ amounts to downloading the symbols (ψᵢB)ⱼ for iε [symbol] ⱼ [symbol] S, where the size | [symbol] |≧j=θⱼ. As mentioned above, since Ψ is a Vandermonde matrix, bⱼ can be reconstructed with j downloaded symbols.

Based on the above partial downloading scheme, let ηⱼ⁽ⁱ⁾=1 if the data collector downloads (ψᵢB)ⱼ to reconstruct bⱼ. Otherwise, let ηⱼ⁽ⁱ⁾=0. Accordingly, the minimum requirement for data construction can be represented as:

$${\sum }_{i = 1}^{S} {η}_{j}^{( i )} = {θ}_{j} , 1 \leq j \leq d$$

The data is μ-reconstructable if there exists ηⱼ⁽ⁱ⁾ε{0,1} for 1≦i≦S and 1≦j≦d such that:

$${μ}_{i} = {\sum }_{i = 1}^{d} {η}_{j}^{( i )} , i ∈ S$$

and the above-equations are satisfied.

In some embodiments, a sufficient condition in terms of {μᵢ}_{iεS} is provided for the two above-mentioned equations to hold.

One condition for the two above-mentioned equations is that, for any subset A [symbol] S:

$${\sum }_{i ∈ A} {μ}_{i} = {\sum }_{i ∈ A} {\sum }_{i = 1}^{d} {η}_{j}^{( i )} = {\sum }_{i = 1}^{d} {\sum }_{i ∈ A} {η}_{j}^{( i )} \leq {\sum }_{j = 1}^{d} min \{ {θ}_{j} , \vert A \vert \}$$

Since Σ_{iεA}ηⱼ⁽ⁱ⁾≦|A| and Σ_{iεA}ηⱼ⁽ⁱ⁾≦Σ_{iεS}ηⱼ⁽ⁱ⁾=θⱼ for all 1≦j≦d. Denoting the sorted {μᵢ}_{iεS} in decreasing order as μ⁽¹⁾≧μ⁽²⁾≧ . . . ≧μ^{(S)} provides:

$${\sum }_{i = 1}^{l} {μ}^{( i )} \leq {\sum }_{j = 1}^{d} min \{ {θ}_{j} , l \}$$

$$for 1 \leq l \leq d , and$$

$${\sum }_{i = 1}^{S} {μ}^{( i )} = {\sum }_{j = 1}^{d} {θ}_{j} .$$

Since θⱼ=min{j, K}, the above-mentioned equations can be represented as:

$${\sum }_{i = 1}^{l} {μ}^{( i )} \leq dl - \frac{l ( l - 1 )}{2}$$

$$for 1 \leq l \leq d , and$$

$${\sum }_{l = 1}^{S} {μ}^{( l )} = M .$$

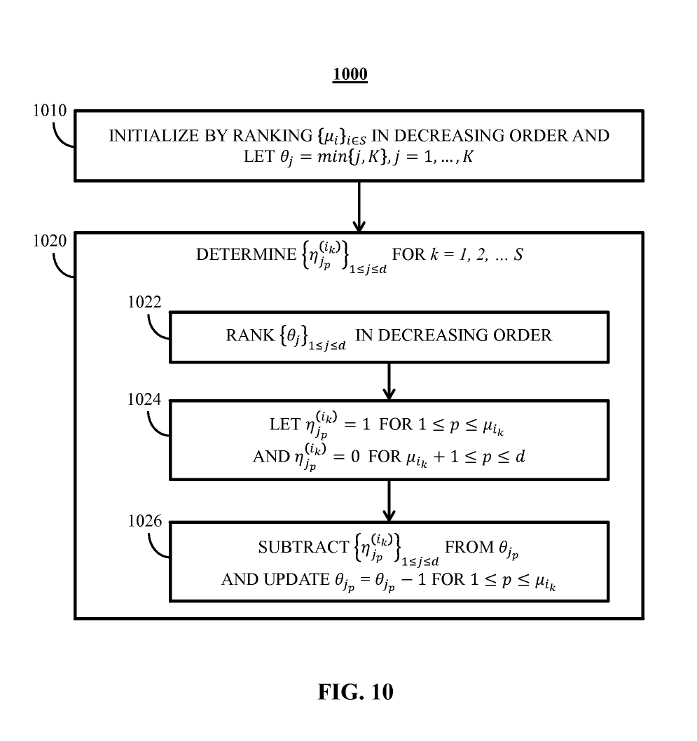

In some embodiments, the sufficiency of the condition can be tested via an illustrative partial downloading scheme shown in FIG. 10. More particularly, given {μᵢ}_{iεS} satisfying the two above-mentioned equations.

$${\{ {η}_{{j}_{p}}^{( {i}_{k} )} \}}_{i ∈ S , 1 \leq j \leq d}$$

can be determined.

Turning to FIG. 10, process 1000 can begin by initializing at 1010. Such an initialization can include ranking {μᵢ}_{iεS} in decreasing order μᵢ_{₁}≧μᵢ_{₂}≧ . . . ≧μᵢ_{_{S}} and letting θⱼ=min{j, K}, j=1, . . . , K.

At 1020, process 1000 can then determine

$${\{ {η}_{{j}_{p}}^{( {i}_{k} )} \}}_{1 \leq j \leq d}$$

for k=1, 2, . . . S. At 1022, process 1000 can include ranking {θⱼ}_{1≦j≦d} in decreasing order θⱼ_{₁}≧θⱼ_{₂}≧ . . . ≧θⱼ_{_{d}}. At 1024, process 1000 can then let

$${η}_{{j}_{p}}^{( {i}_{k} )} = 1$$

for 1≦p≦μᵢ_{ₖ} and letting

$${η}_{{j}_{p}}^{( {i}_{k} )} = 0$$

for μᵢ_{ₖ}+1≦p≦d. At 1026, process 1000 can subtract

$${\{ {η}_{{j}_{p}}^{( {i}_{k} )} \}}_{1 \leq j \leq d}$$

from θⱼ_{ₚ} and update θⱼ_{ₚ}=θⱼ_{ₚ}−1 for 1≦p≦μᵢ_{ₖ}.

It should be noted that the above symbol selection scheme of FIG. 10 can be used to obtain ηⱼ⁽ⁱ⁾, iεS, 1≦j≦d to reconstruct the data.

As described above, in some embodiments, the data collector can determine the number of symbols to be downloaded from each channel and storage node based on suitable channel and power allocation schemes.

In accordance with some embodiments, the number of symbols to be downloaded over channel j can be given by:

Xⱼ=c(PⱼΣ_{iεS}βⱼ⁽ⁱ⁾|gⱼ⁽ⁱ⁾|²) (10)

where: iεS;

jε [symbol] ;

$$c ( \cdot ) is c ( {P}_{j} {\sum }_{i ∈ S} {β}_{j}^{( i )} {\vert {g}_{j}^{( i )} \vert}^{2} ) = \frac{WT}{B} {log}_{2} ( 1 + \frac{{P}_{j} {\sum }_{i ∈ S} {β}_{j}^{( i )} {\vert {g}_{j}^{( i )} \vert}^{2}}{{σ}^{2}} )$$

as described above in connection with equation (6);

βⱼ⁽ⁱ⁾=1 if the data collector (e.g., data collector 120 in FIGS. 1 and 2) downloads symbols from storage node i using channel j and βᵢ⁽ⁱ⁾=0 otherwise; and

Pⱼ be the transmission power for channel j.

Based on equation (10), the number of symbols μᵢ to be downloaded from a storage node i can then be calculated as:

μᵢ=Σⱼ₌₁^{N}βⱼ⁽ⁱ⁾Xⱼ, iεS (11)

In some embodiments, it may be desirable to minimize the total power used across all N channels during data reconstruction. A minimum total power used during such a reconstruction can be represented in some embodiments as:

$${min}_{{\{ {β}_{j}^{( i )} , {P}_{j} \}}_{i ∈ S , j ∈ 𝒩}} {\sum }_{j ∈ 𝒩} {P}_{j}$$

such that: the data is μ-reconstructable as described above;

Xⱼ=c (PⱼΣ_{iεS}βⱼ⁽ⁱ⁾|gⱼ⁽ⁱ⁾|²);

μᵢ=Σⱼ₌₁^{N}βⱼ⁽ⁱ⁾Xⱼ, iεS;

Xⱼε{0, 1, 2, . . . , α} for jε [symbol] ; and

Σ_{iεS}βⱼ⁽ⁱ⁾≦1, jε [symbol] βⱼ⁽ⁱ⁾ε{0,1}.

As reflected by Σ_{iεS}βⱼ⁽ⁱ⁾≦1, jε [symbol] ; βⱼ⁽ⁱ⁾ε{0,1}, in some embodiments, each channel, if used, may be restricted to being used only to transmit symbols from one node.

In accordance with some embodiments, based on channel estimation results, the data collector can run a channel and power allocation process to determine the number of symbols to be downloaded from each storage node. Any suitable channel and power allocation process can be used in some embodiments.

According to equation (10), letting p(·) be the inverse function c(·) of the capacity function in equation (6), the transmission power of a channel j can be represented as:

$${P}_{j} = \frac{p ( {X}_{j} )}{{\sum }_{i ∈ S} {β}_{j}^{( i )} {\vert {g}_{j}^{( i )} \vert}^{2}} \qquad ( 12 )$$

Based on equation (12), the minimum total power used during a reconstruction, represented above by

$${min}_{{\{ {β}_{j}^{( i )} , {P}_{j} \}}_{i ∈ S , j ∈ 𝒩}} {\sum }_{j ∈ 𝒩} {P}_{j} ,$$

can alternatively be represented as

$${min}_{{\{ {β}_{j}^{( i )} , {X}_{j} \}}_{i ∈ S , j ∈ 𝒩}} {\sum }_{j ∈ 𝒩} \frac{p ( {X}_{j} )}{{\sum {β}_{j}^{( i )}}_{i ∈ S} {\vert {g}_{j}^{( i )} \vert}^{2}} \\ such that \text{:} \\ {\sum }_{j = 1}^{N} {X}_{j} = M ; {X}_{j} ∈ {ℤ}^{+} ⋃ \{ 0 , 1 \} ; \\ {\sum }_{i ∈ S} {β}_{j}^{( i )} \leq 1 , j ∈ 𝒩 ; {β}_{j}^{( i )} ∈ \{ 0 , 1 \} \qquad ( 13 )$$

In some embodiments, each channel jεN can then be assigned to a node i as follows:

βⱼ⁽ⁱ^{ⱼ}⁾=1, for iⱼ=arg max|gⱼ⁽ⁱ⁾|; and βⱼ⁽ⁱ⁾=0, otherwise.

Letting

$${p}_{j} ( {X}_{j} ) = \frac{1}{{\vert {g}_{j}^{( {i}_{j} )} \vert}^{2}} p ( {X}_{j} ) ,$$

the power allocation problem then becomes:

$${min}_{\{ {X}_{i} \} i ∈ 𝒩} {\sum }_{j = 1}^{N} {p}_{j} ( {X}_{j} ) \\ such that \text{:} \\ {\sum }_{j = 1}^{N} {X}_{j} = M ; {X}_{j} ∈ {ℤ}^{+} ⋃ \{ 0 \} . \qquad ( 14 )$$

In some embodiments, a greedy algorithm can be used to find this minimum power. For example, in some embodiments, the minimum power can be found as follows:

1) Initialize Xⱼ=0 for jε [symbol] ;

2) While Σ_{jεN}Xⱼ<M, do the following:
a) For jε [symbol] , let ΔPⱼ=pⱼ(Xⱼ+1)−pⱼ(Xⱼ) be the power increment for channel j; and
b) Find the channel j₀=arg min [symbol] ΔPⱼ with the minimum power increment, and update Xⱼ_{₀}←Xⱼ_{₀}+1; and

3) Output Xⱼ, for jε [symbol] .

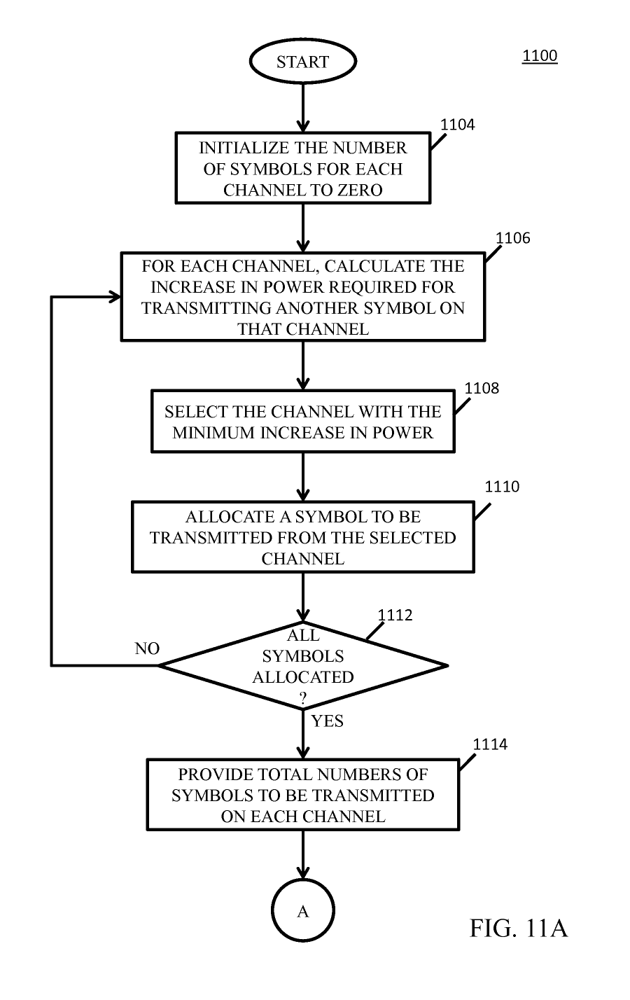

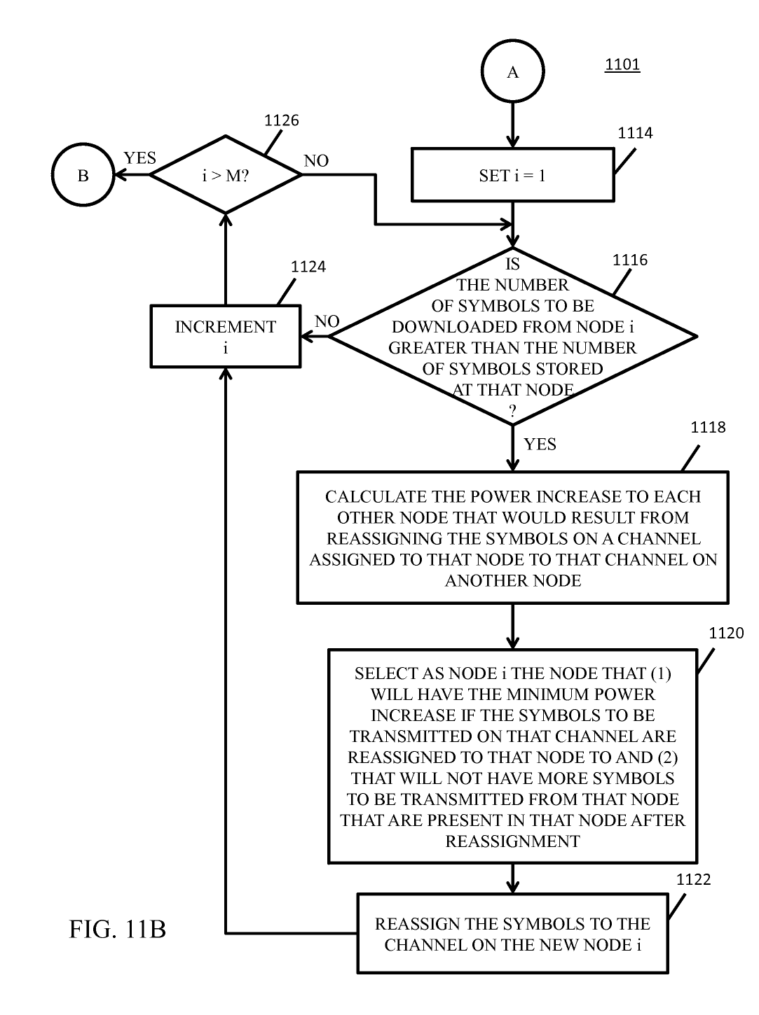

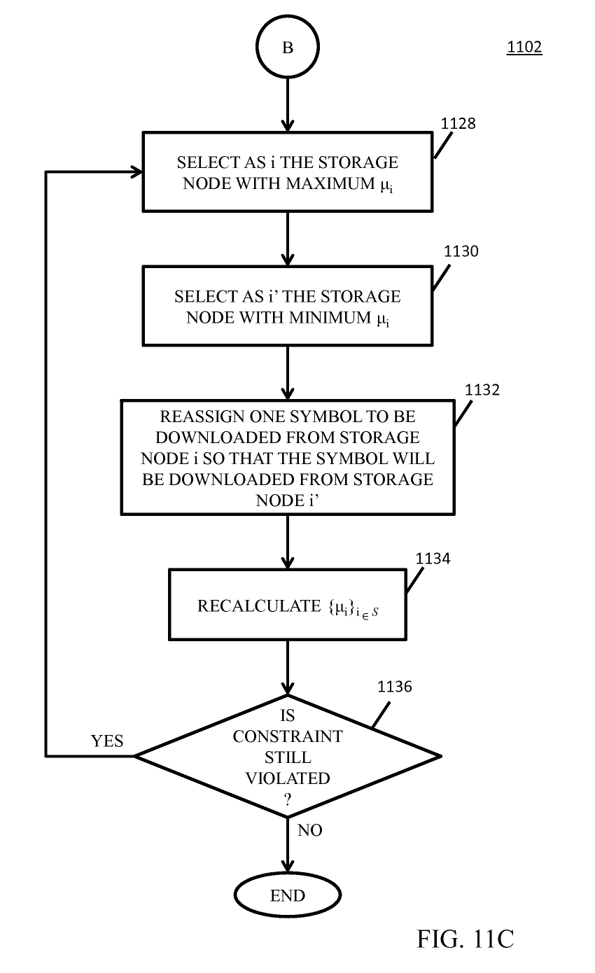

Turning to FIG. 11A, an example of a process 1100 for finding a minimum power is illustrated. In some embodiments, process 1100 can be implemented in a data collector (e.g., data collector 120 as illustrated in FIGS. 1 and 2).

As shown, after process 1100 begins, the process can initialize the number of symbols for each channel to zero at 1104. Next, at 1106, process 1100 can, for each channel, calculate the increase in power required for transmitting another symbol on that channel. This calculation can be performed in any suitable manner. For example, as described above, this calculation can be performed using the following equation: ΔPⱼ=pⱼ(Xⱼ+1)−pⱼ(Xⱼ). Process 1100 can then select the channel with the minimum increase in power at 1108. Next, at 1110, process 1100 can allocate a symbol to be transmitted on the selected channel. At 1112, process 1100 can determine whether all symbols have been allocated. If not, process 1100 can loop back to 1106. Otherwise, at 1114, process 1100 can provide the total numbers of symbols to be transmitted on each channel to a suitable process that provides this data to the storage nodes via a feedback channel.

As described above, based on the solution {Xⱼ} [symbol] obtained by a greedy algorithm, the number of symbols assigned to each storage node can be given by μᵢ= [symbol] βⱼ⁽ⁱ⁾Xⱼ for iεS, in some embodiments.

In some embodiments, if {μᵢ}_{iεS} violates a constraint that μᵢ≦α, iεS and the data collector is operating at the MSR point, an adjustment can be performed by identifying each storage node i with μᵢ>α, and reassigning symbols to be downloaded on one of the storage nodes channels to another storage node to decrease μᵢ, until μᵢ<α for all iεS. This adjustment can be performed in any suitable manner in some embodiments. For example, in some embodiments, the adjustment can be performed as follows:
1) While μᵢ>α for some iεS, do the following:
   a) Find a storage node i with μᵢ>α and the set of assigned channels denoted as [symbol] ᵢ={j: βⱼ⁽ⁱ⁾=1};
   b) Find the storage node i′εS\{i} [symbol] S′ and the channel jε [symbol] ᵢ that minimizes the power increment of reassigning the X symbols in channel j to node i′ such that μ_{i′}+Xⱼ≦α, i.e.,

$$( {i}_{0} , {j}_{0} ) = {argmin}_{( {i}^{′} , j ) ∈ {S}^{′} \times {𝒩}_{i : {μ}_{{i}^{′}}} + {X}_{j} \leq α} {p}_{j}^{( {i}^{′} )} ( {X}_{j} ) - {p}_{j}^{( i )} ( {X}_{j} ) \qquad ( 15 )$$

2) Reassign the Xⱼ_{₀} symbols in channel j₀ to storage node i₀, by letting βⱼ_{₀}⁽ⁱ^{₀}⁾=1 and βⱼ_{₀}⁽ⁱ⁾=0.

Turning to FIG. 11B, an example of a process 1101 for performing an adjustment when the data collector is operating at the MSR point is illustrated. In some embodiments, process 1101 can be implemented in a data collector (e.g., data collector 120 as illustrated in FIGS. 1 and 2). As shown, process 1101 may be a continuation of process 1100 of FIG. 11A. In some embodiments, and in some instances, such as when the data collector is not operating at the MSR point, process 1101 can be skipped or omitted.

After process 1101 begins, the process can set an index i equal to one at 1114. Next, at 1116, the process can determine if the number of symbols to be downloaded from node i is greater than the number of symbols stored at that node. If so, process 1101 can then calculate the power increase to each other node that would result from reassigning the symbols on a channel assigned to that node to that channel on another node at 1118. This calculation can be made in any suitable manner. For example, in some embodiments, the calculation can be made using: pⱼ^{(i′)}(Xⱼ)−pⱼ⁽ⁱ⁾(Xⱼ). Next, at 1120, process 1101 can select as node i the node that (1) will have the minimum power increase if the symbols to be transmitted on that channel are reassigned to that node to and (2) that will not have more symbols to be transmitted from that node that are present in that node after reassignment. At 1122, process 1101 can the reassign the symbols to the channel on the new node i.

After performing 1122 or determining at 1116 that the number of symbols to be downloaded from node i is not greater than the number of symbols stored at that node, process 1101 can branch to 1124 at which i can be incremented. Then, at 1126, process 1101 can determine whether i is greater than M, the number of symbols to be downloaded. If not, process 1101 can loop back to 1116. Otherwise, process 1101 can complete.

In some embodiments, if the data collector is operating at the MBR point, the following constraint can be applied against {μᵢ}_{iεS}:

$${\sum }_{i = 1}^{l} {μ}^{( i )} \leq dl - \frac{l ( l - 1 )}{2} , for 1 \leq l \leq d ;$$

$$and$$

$${\sum }_{l = 1}^{S} {μ}^{( l )} = M$$

As described above, this constraint can require that μ⁽¹⁾≦d, μ⁽¹⁾+μ⁽²⁾≦2d−1, μ⁽¹⁾+μ⁽²⁾+μ⁽³⁾≦3d−3, etc.

In some embodiments, if {μᵢ}_{iεS} violates this constraint and the data collector is operating at the MBR point, an adjustment can be performed as follows:
1) Select as i the storage node with the maximum μᵢ;
2) Select as i′ the storage node with the minimum μᵢ;
3) Reassign one symbol to be downloaded from storage node i so that the symbol will be downloaded from storage node i′;
4) Recalculate {μᵢ}_{iεS};
5) Determine if the constraint is still violated; and
6) If so, loop back to 1), otherwise end.

Turning to FIG. 11C, an example of a process 1102 for performing an adjustment when the data collector is operating at the MBR point is illustrated. In some embodiments, process 1102 can be implemented in a data collector (e.g., data collector 120 as illustrated in FIGS. 1 and 2). As shown, process 1102 may be a continuation of process 1101 of FIG. 11B. In some embodiments, and in some instances, such as when the data collector is not operating at the MBR point, process 1102 can be skipped or omitted.

After process 1102 begins, the process can select as i the storage node with the maximum μᵢ at 1128. Next, at 1130, process 1102 can select as i′ the storage node with the minimum μᵢ. Then, at 1132, the process can reassign one symbol to be downloaded from storage node i so that the symbol will be downloaded from storage node i′. At 1134, process 1102 can recalculate {μᵢ}_{iεS} as described above. Then, at 1136, the process can determine if the constraint is still violated. If so, the process can loop back to 1128. Otherwise, the process can end.

As described above, in some embodiments, the data collector can regenerate data of a failed storage node by downloading d data symbols from other storage nodes. These downloaded data symbols can then be loaded onto a new storage node.

In some embodiments, when the data collector is operating at the MSR point, this can be accomplished by downloading one symbol from each of any α+K−1 storage nodes. More particularly, for example, in some embodiments, when the data collector is operating at the MSR point and α≧K−1, this can be accomplished by choosing any d=α+K−1 storage nodes and downloading one symbol from each of the d nodes.

In some embodiments, when the data collector is operating at the MBR point, this can be accomplished by downloading one symbol from each of any a storage nodes. More particularly, for example, in some embodiments, when the data collector is operating at the MBR point, this can be accomplished by selecting any d=α nodes and downloading one symbol from each of them.

Then, the wireless resource allocation for both the MSR and MBR points can be similarly formulated as described above, i.e., to minimize the power consumption of downloading d symbols from d storage nodes.

In some embodiments, the data collector can attempt to minimize the total power used to download these symbols subject to the constraints of: Σ_{iεS}μᵢ=d; and μᵢε{0,1} for iεS.

This attempt to minimize the total power can be performed in any suitable manner. For example, in some embodiments, a greedy algorithm can be used to find this minimum power. For example, in some embodiments, the minimum power can be found as follows:
1) Initialize Xⱼ=0 for jε [symbol] ;
2) While [symbol] Xⱼ<d, do the following:
   a) For jε [symbol] where Xⱼ equals 0, calculate the power for transmitting one symbol pⱼ(1) on channel j; and
   b) Find the channel j₀=arg min [symbol] pⱼ(1) with the minimum power, and select that channel j as to be used to download a symbol: Xⱼ_{₀}←1; and
3) Output Xⱼ for jε [symbol] .

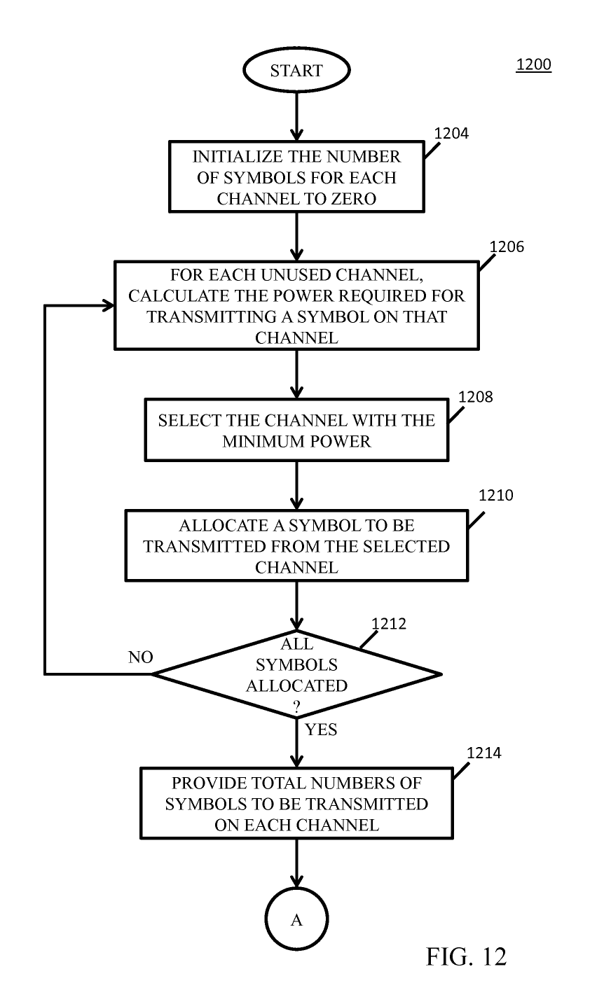

Turning to FIG. 12, an example of a process 1200 for finding a minimum power is illustrated. In some embodiments, process 1200 can be implemented in a data collector (e.g., data collector 120 as illustrated in FIGS. 1 and 2).

As shown, after process 1200 begins, the process can initialize the number of symbols for each channel to zero at 1204. Next, at 1206, process 1200 can, for each unused channel, calculate the power required for transmitting a symbol on that channel. This calculation can be performed in any suitable manner. Process 1200 can then select the channel with the minimum power at 1208. Next, at 1210, process 1100 can allocate a symbol to be transmitted on the selected channel. At 1212, process 1100 can determine whether all symbols have been allocated. If not, process 1200 can loop back to 1206. Otherwise, at 1214, process 1200 can provide the total numbers of symbols to be transmitted on each channel to any suitable process that needs this data. In some embodiments, in the event that the allocated symbols {μᵢ}_{iεS} violates a constraint that μᵢ≦1, iεS, a reassignment method similar to that described above in connection with FIG. 11B can be used to reassign one or more of the allocated symbols for regeneration.

Accordingly, methods, systems, and media for partial downloading in wireless distributed networks are provided.

It should be noted that processes of FIGS. 3, 5-7, 9, 10, 11A, 11B, 11C, and 12 can be performed concurrently in some embodiments. It should also be noted that the above steps of the flow diagrams of FIGS. 3, 5-7, 9, 10, 11A, 11B, 11C, and 12 may be executed or performed in any order or sequence not limited to the order and sequence shown and described in the figures. Furthermore, it should be noted, some of the above steps of the flow diagrams of FIGS. 3, 5-7, 9, 10, 11A, 11B, 11C, and 12 may be executed or performed substantially simultaneously where appropriate or in parallel to reduce latency and processing times. And still furthermore, it should be noted, some of the above steps of the flow diagrams of FIGS. 3, 5-7, 9, 10, 11A, 11B, 11C, and 12 may be omitted.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of embodiment of the invention can be made without departing from the spirit and scope of the invention, which is only limited by the claims which follow. Features of the disclosed embodiments can be combined and rearranged in various ways.

What is claimed is:

1. A method for selecting numbers of symbols to be transmitted on a plurality of channels, comprising:
for each of the plurality of channels, calculating using a hardware processor an increase in power that will be used by that channel if it transmits a symbol;
selecting one of the plurality of channels with the smallest increase in power using the hardware processor; and
allocating the symbol to the one of the plurality of channels using the hardware processor.

2. The method of claim 1, further comprising determining a reduction in the number of symbols to be transmitted on a channel.

3. The method of claim 2, further comprising:
determining whether the number of symbols to be transmitted from a node exceeds the number of symbols stored at the node;
calculating a power increase that would occur by reassigning a symbol from a channel associated with the node to a channel associated with each of a plurality of other nodes; and
selecting one of the plurality of others nodes as the node to which the symbol is to be reassigned based on the calculating.

4. The method of claim 3, further comprising transmitting symbols at a minimum-storage regenerating (MSR) point.

5. The method of claim 2, further comprising:
selecting a first node of a plurality of nodes as having a maximum number of symbols to be transmitted;
selecting a second node of the plurality of nodes as having a minimum number of symbols to be transmitted; and
reassigning a symbol as to be transmitted from the second node instead of the first node.

6. The method of claim 5, further comprising transmitting symbols at a minimum-bandwidth regenerating (MBR) point.

7. A system for selecting numbers of symbols to be transmitted on a plurality of channels, comprising:
at least one hardware processor that:
for each of the plurality of channels, calculates an increase in power that will be used by that channel if it transmits a symbol;
selects one of the plurality of channels with the smallest increase in power; and
allocates the symbol to the one of the plurality of channels.

8. The system of claim 7, wherein the at least one hardware processor also determines a reduction in the number of symbols to be transmitted on a channel.

9. The system of claim 8, wherein the at least one hardware processor also:
determines whether the number of symbols to be transmitted from a node exceeds the number of symbols stored at the node;
calculates a power increase that would occur by reassigning a symbol from a channel associated with the node to a channel associated with each of a plurality of other nodes; and
selects one of the plurality of others nodes as the node to which the symbol is to be reassigned based on the calculating.

10. The system of claim 9, wherein the at least one hardware processor also causes symbols to be transmitted a minimum-storage regenerating (MSR) point.

11. The system of claim 8, wherein the at least one hardware processor also:
selects a first node of a plurality of nodes as having a maximum number of symbols to be transmitted;
selects a second node of the plurality of nodes as having a minimum number of symbols to be transmitted; and
reassigns a symbol as to be transmitted from the second node instead of the first node.

12. The system of claim 11, wherein the at least one hardware processor also causes symbols to be transmitted at a minimum-bandwidth regenerating (MBR) point.

13. A non-transitory computer-readable medium containing computer-executable instructions that, when executed by a processor, cause the processor to perform a method for selecting numbers of symbols to be transmitted on a plurality of channels, the method comprising:
for each of the plurality of channels, calculating an increase in power that will be used by that channel if it transmits a symbol;
selecting one of the plurality of channels with the smallest increase in power; and
allocating the symbol to the one of the plurality of channels.

14. The non-transitory computer-readable medium of claim 13, wherein the method further comprises determining a reduction in the number of symbols to be transmitted on a channel.

15. The non-transitory computer-readable medium of claim 14, wherein the method further comprises:
determining whether the number of symbols to be transmitted from a node exceeds the number of symbols stored at the node;
calculating a power increase that would occur by reassigning a symbol from a channel associated with the node to a channel associated with each of a plurality of other nodes; and
selecting one of the plurality of others nodes as the node to which the symbol is to be reassigned based on the calculating.

16. The non-transitory computer-readable medium of claim 15, wherein the method further comprises transmitting symbols at a minimum-storage regenerating (MSR) point.

17. The non-transitory computer-readable medium of claim 14, wherein the method further comprises:
selecting a first node of a plurality of nodes as having a maximum number of symbols to be transmitted;
selecting a second node of the plurality of nodes as having a minimum number of symbols to be transmitted; and
reassigning a symbol as to be transmitted from the second node instead of the first node.

18. The non-transitory computer-readable medium of claim 17, wherein the method further comprises transmitting symbols at a minimum-bandwidth regenerating (MBR) point.
